(19) United States
(12) Patent Application Publication
(10) Pub. No.: US 2006/0284473 A1
(43) Pub. Date: Dec. 21, 2006

(54) WHEEL-COVER

(76) Inventor: Larry Dennis Fahey, Shoreline, WA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/420,433

(22) Filed: May 25, 2006

Related U.S. Application Data
(60) Provisional application No. 60/684,887, filed on May 25, 2005.

(51) Int. Cl. B60B 7/00

(52) U.S. Cl. 301/37.101

(57) ABSTRACT

This invention relates to an automobile road-wheel cover and, more particularly, this invention relates to a road-wheel cover with an extension that extends beyond that of the road-wheel it covers, giving the illusion of an over sized rim paired with a low profile tire.

### PRIORITY

This application claims the benefit of U.S. Provisional Application No. 60/684,887, filed on May, 25, 2005.

### BACKGROUND OF THE INVENTION

1. Field of the Invention

This invention relates to an automobile road-wheel cover and, more particularly, this invention relates to a road-wheel cover with at least a one inch integral extension of its radius beyond that of the road-wheel it covers, thereby having a diameter at least two inches more than that of the road wheel that extends out and over part of the tire, thus giving the illusion of an over sized rim paired with a low profile tire.

2. Description of Related Arts

The function of this invention is carried out today by purchasing expensive, low profile tires paired with expensive, oversized rims. It is possible to purchase wheel covers instead of expensive rims, but currently there are no wheel covers that cover more than just the existing wheel. As such, there is no illusion of an expensive, custom rim, nor is there the appearance of a low profile tire. The present invention provides users a low cost option of having the appearance of a sporty custom wheel with a low profile tire at minimal cost.

The present invention provides several advantages over currently existing wheel covers. With respect to currently existing wheel covers, none of them provide the illusion of an expensive, oversized custom rim. Nor do they provide the appearance of an expensive, low profile tire. Further, the present invention provides a low cost option to purchasers to have an easily installable wheel cover that gives the appearance of an expensive wheel paired with a low profile tire. Finally, it provides the ability for purchasers to keep their existing wheel cover and to only purchase a separate wheel cover extender to give the allusion of an expensive wheel paired with a low profile tire, thereby further minimizing the costs to the consumer.

### BRIEF DESCRIPTION OF THE DRAWING

The above and other objects and the attendant advantages of the present invention will become readily apparent by reference to the following detailed description when considered in conjunction with the accompanying drawings, in which:

FIG. 1 is a perspective view of the present invention from a frontal viewpoint.

FIG. 2 is a perspective, side view of the present invention showing the angled portion.

FIG. 3 is a perspective, side view of the present invention showing the flexible extender.

FIG. 4 is a perspective frontal view of the separate extender ring of the present invention.

### DETAILED DESCRIPTION OF THE INVENTION

### Brief Description of the Invention

As the basis for the present invention, the conventional art involves purchasing expensive, chrome wheels paired with expensive, low profile tires. It is presently popular to have large, expensive chrome wheels combined with expensive, low profile tires.

The present invention utilizes a low cost wheel cover that fits directly onto the existing automobile rim that comprises a central wheel cover portion and an extender or a separate extender that can be utilized with an existing wheel cover. Alternatively, the central wheel cover portion can have an integrated, flexible lip that extends out and over the wheel and can either lay directly on the wheel or be slightly raised above the wheel. All of the embodiments give the appearance of an expensive, high end wheel paired with an expensive, high end, low profile tire. There is a potential problem with the extension protruding out over the wheel in that if the driver experiences a flat tire or the tire loses air the tire will widen. If this occurs the tire will ultimately put pressure on the wheel cover extender and could possibly cause the wheel cover to become detached and thus to be forced off the wheel. Therefore, a feature of one design is a flexible extender. In yet another model the extender is hingedly attached to the central.

The features of the invention believed to be novel are set forth with particularity in the appended claims. However, the invention itself, both as to organization and method of operation, together with further objects and advantages thereof may be best understood by reference to the following description taken in conjunction with the accompanying drawings.

### Embodiments of the Invention

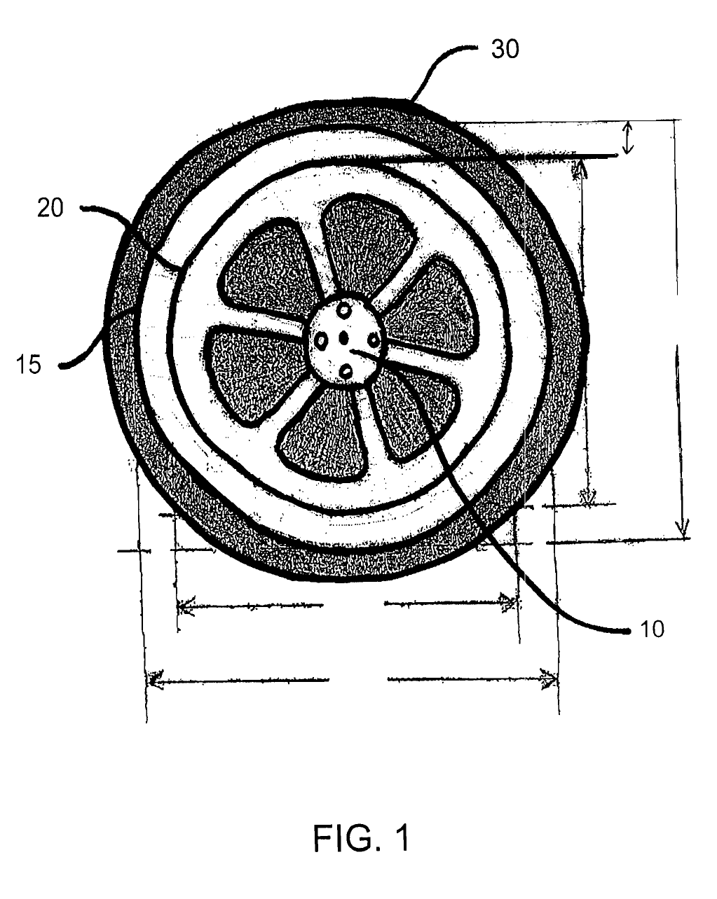

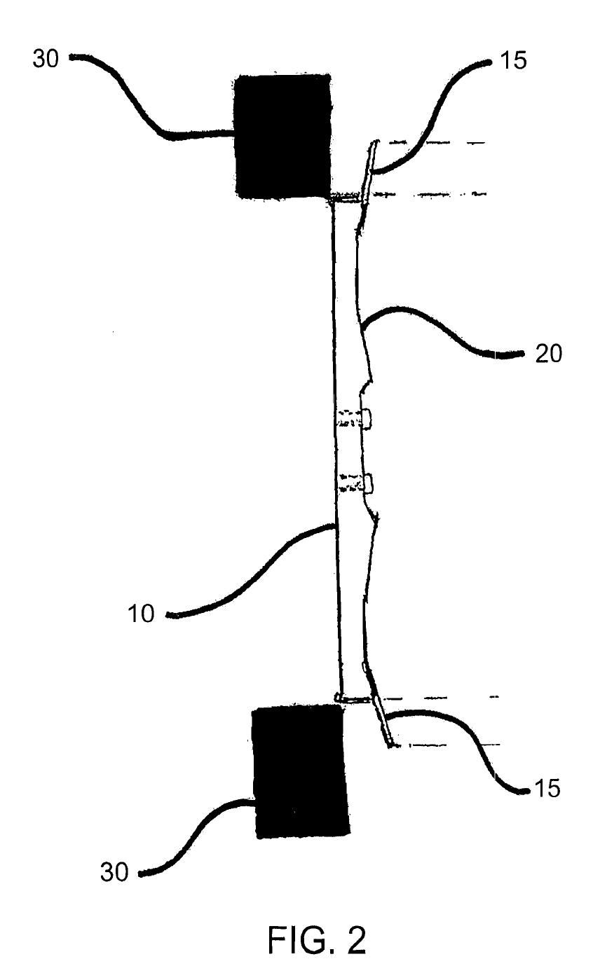

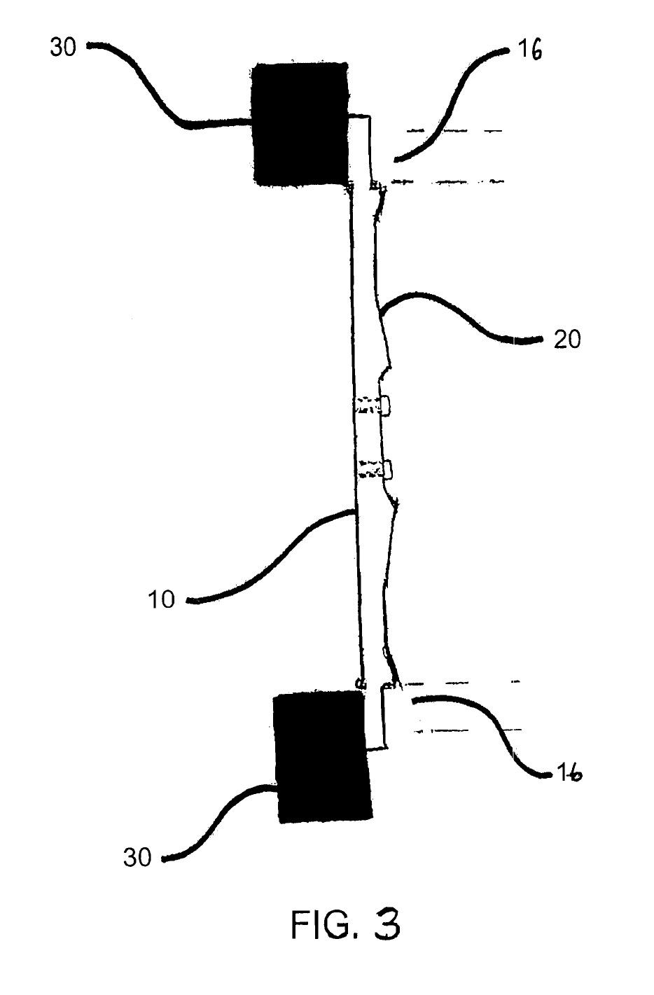

The present invention provides a wheel cover that gives the illusion of an expensive wheel paired with an expensive, low profile wheel. Examples of this invention are explained with reference to FIG. 1, FIG. 2 FIG. 3 and FIG. 4.

FIG. 1 is a perspective view of a the wheel extender shown from a frontal view.

FIG. 2 is a perspective side view of the wheel extender utilizing an angled extender.

FIG. 3 is a perspective, side view of the present invention showing the flexible extender.

FIG. 4 is a perspective frontal view of the separate extender ring of the present invention.

The operation of the wheel cover 10 can be understood by reference to FIG. 1. To operate the wheel cover 10 a standard tire 30 is mounted on a standard wheel. The wheel cover 10 is affixed to the standard wheel the same as you would affix any wheel cover of the existing art. The difference is that the wheel cover 10 of the present invention gives the appearance of an expensive custom wheel paired with an expensive, low profile wheel due the wheel cover extender portion 15.

In one form the central wheel portion 20 and the extender portion 16 are constructed from one material and in one piece, as is shown in FIG. 3. The material must be somewhat flexible because the extender portion 16 protrudes out over the existing wheel 30 and may actually make contact with the wheel 30 thereby providing an exceptionally clean look. However, because the extender portion is in contact with the wheel 30 it must be able to flex and adjust in order to maintain contact with the tire 30. Because the tire 30 tends to change shape due to rotational speed, fluctuating air pressure or flats, the extender portion 16 must be totally adaptive, flexing and changing with the shape of the tire 30. Thus, if the extender 16 is made from a flexible material it will not crack or break when the tire changes shape; it will conform to the contour of the wheel as the wheel changes in size and shape; and it will continuously provide a clean look due to the perpetual contact with the wheel surface.

In another form the central wheel portion 20 and the extender portion 15 of the wheel cover 10 are made from a more solid material, such as metal, chrome or a solid inflexible plastic. There are at least two ways to configure this rigid material.

This first is to hingedly attach the extender portion 15 to the central wheel portion 20. By using a hinge it would allow for the extender to maintain contact with the wheel 30 and would allow for variation in wheel size, as described above, thereby preventing breakage of the extender portion 15 and preventing the wheel portion 20 from coming off of the wheel.

A second variation would be to angle the extender portion 15 away from the wheel 30. This would not allow the extender to make contact with the tire 30 but it would prevent the extender portion 15 from breaking if the tire changes shape. This configuration is also very simple and would be inexpensive to produce. The extender portion 15 and the central wheel portion 20 could be made in one piece or they could be separate.

FIG. 2 shows the present invention from a side view utilizing a solid material. As is more clearly shown in this figure, the cover extender 15 may be angled in order to allow room for the tire 30. This angling prevents the tire 30 from rubbing on the cover extender 15 and prevents breakage of the cover extender 15.

Another variation is where the cover extender 15 is angled and is hingedly attached to the center portion of the wheel cover 10. This could be in the form of a piano hinge or any other hinge. In this way the cover extender would tightly fit against the tire 30 thereby increasing and improving the illusion.

Yet another variation of this angle to prevent rubbing is a flexible wheel cover extender 16, as previously described. The wheel cover extender 16 could be angled and could be made of a flexible plastic, rubber or any other flexible material that could match the wheel cover 10.

Still another variation is an extender that simply attaches to an existing wheel cover but again provides the appearance of a more expensive wheel. The extender is shown in FIG. 4.

It is readily apparent that the above-described invention has the advantages of wide commercial utility. It may be understood that the specific form of the invention hereinabove described is intended to be representative only, and certain modifications within the scope of those teachings will be apparent to those skilled in the art without departing from the spirit and scope of the invention.

While the foregoing invention has been shown and described with reference to preferred variations, it will be understood by those possessing skill in the art that various changes and modifications may be made without departing from the spirit and scope of the invention. Accordingly, reference should be made to the following claims in determining the full scope of the invention.

What I claim is:

1. A wheel-cover for a wheel comprising:
a central wheel cover portion with an external radius that is similar to an external radius of a corresponding wheel, and an extender portion with an internal radius similar to said external radius of said central wheel cover and an external radius that is greater than that of said central wheel cover radius.

2. The wheel-cover of claim 1, wherein said central wheel-cover portion and said extender portion are contiguous

3. The wheel-cover of claim 2, wherein said extender portion is made from one piece of flexible material.

4. The wheel-cover of claim 2, wherein said central wheel-cover portion and said extender portion are contiguous and are made from one piece of material and said extender portion is angled out and away from a tire.

5. The wheel-cover of claim 1, wherein said central wheel-cover portion and said extender portion are made from two separate pieces of material and said extender portion is hingedly attached to said central wheel cover portion.

6. A wheel-cover extender comprising:
an extender that fits onto an existing central wheel cover where an internal radius of said extender is similar to an external radius of said existing central wheel cover and an external radius of said wheel cover extender is greater than that of said central wheel cover external radius.

7. The wheel-cover extender of claim 6, wherein said extender is flexible.

8. The wheel-cover extender of claim 6, wherein said wheel-cover is hingedly attached to said central wheel cover.
